(19) United States
(12) Patent Application Publication
(10) Pub. No.: US 2026/0104520 A1
(43) Pub. Date: Apr. 16, 2026

(54) 3D STANDARD SAMPLE FOR EVALUATING X-RAY APPARATUS

(71) Applicant: SAMSUNG ELECTRONICS CO., LTD., Suwon-si (KR)

(72) Inventors: Seungryeol LEE, Suwon-si (KR); Taejin KWON, Suwon-si (KR); Jungho MOON, Suwon-si (KR); Garam CHOI, Suwon-si (KR); Sukbum HONG, Suwon-si (KR); Myoungki AHN, Suwon-si (KR); Hyeongcheol LEE, Suwon-si (KR)

(73) Assignee: SAMSUNG ELECTRONICS CO., LTD., Suwon-si (KR)

(21) Appl. No.: 19/190,252

(22) Filed: Apr. 25, 2025

(30) Foreign Application Priority Data
Oct. 14, 2024 (KR) 10-2024-0139365

(51) Int. Cl. G01T 7/00

(52) U.S. Cl. CPC G01T 7/00

(57) ABSTRACT

Provided is a three-dimensional standard sample including a sample body, a first pattern group and a second pattern group in the sample body, each of the first pattern group and the second pattern group including a pattern layer that includes a metal pattern, and an interlayer layer that includes an insulating material, and a plurality of combination patterns respectively including the first pattern group and the second pattern group, wherein at least one of the plurality of combination patterns is in a central portion of the sample body and an edge portion of the sample body.

### CROSS-REFERENCE TO RELATED APPLICATION

This application claims priority to Korean Patent Application No. 10-2024-0139365 filed on Oct. 14, 2024 in the Korean Intellectual Property Office, the disclosure of which is incorporated herein in its entirety by reference.

### BACKGROUND

Embodiments of the present disclosure relate to a three-dimensional standard sample for evaluating X-ray equipment, and more particularly, to a three-dimensional standard sample for evaluating X-ray equipment, capable of evaluating performance of various semiconductor structures and evaluating performance of a semiconductor structure in a depth direction.

In addition to semiconductor package products, the lamination method is being widely introduced in pre-process products (for example, BVNAD, W2W bonding and the like) in which chips are formed by engraving circuits on semiconductor wafers. Accordingly, the need to inspect or measure lower micro-defects within a 3D structure is increasing. Since existing optical/electron microscope methods have limitations, attempts to utilize new equipment such as ultrasound and X-ray are gradually increasing.

X-ray equipment uses a method in which X-rays may penetrate a sample to view the interior thereof, and there are technologies such as computed laminography (CL) technology and computed tomography (CT) technology. Since CT technology has limitations in the direction of penetration for semiconductor wafer inspection/measurement, CL technology emerged as tilted CT technology.

In the semiconductor industry, semiconductor inspection has been applied with inline X-ray CT/CL equipment. Since such X-ray equipment has been applied to the semiconductor industry relatively recently, various configurations have been proposed for each equipment manufacturer or equipment. For example, there are significant differences in the locations of the source and detector, the locations of the rotation stage and translation stage, the rotating parts, and the like. It is not yet known which method is the best for lower defect inspection and measurement.

Semiconductor chip manufacturers have evaluated X-ray CL/CT equipment using real semiconductor products, but have been experiencing difficulty in quantitative comparison. This is because respective structures within the product have different characteristics, and thus there is a difference in the image depending on the structure. For example, the bump and through-silicon via (TSV) structures within application-specific integrated circuit chips (ASIC) products are different, and thus there is a difference in image quality depending on the structure. Accordingly, it may be difficult to quantitatively analyze which equipment is better based on images alone.

In addition, the current calibration method for X-ray equipment is complex and time-consuming, and tool-to-tool matching (TTTM) is also difficult. X-ray equipment samples are also currently being manufactured and used as different calibration samples (phantom samples) for each equipment manufacturer/equipment.

Samples consisting of multiple metal balls may be used to more accurately determine relative positions between the balls. However, such samples are difficult to design accurately, and there may be limitations in performing precise calibration with a single pattern/single size.

In addition, samples using multiple metal balls have differences from materials used in semiconductor products, which limits the evaluation of X-ray equipment.

### SUMMARY

One or more embodiments provide a three-dimensional standard sample that may respond to various semiconductor structure patterns, including a three-dimensional performance evaluation in a depth direction, with an X-ray apparatus.

One or more embodiments also provide a three-dimensional standard sample that enables quantitative evaluation of an X-ray apparatus, thereby enabling selection of a reliable apparatus.

According to an aspect of one or more embodiments, there is provided a three-dimensional standard sample including a sample body, a first pattern group and a second pattern group in the sample body, each of the first pattern group and the second pattern group including a pattern layer that includes a metal pattern, and an interlayer layer that includes an insulating material, and a plurality of combination patterns respectively including the first pattern group and the second pattern group, wherein at least one of the plurality of combination patterns is in a central portion of the sample body and an edge portion of the sample body.

According to another aspect of one or more embodiments, there is provided a three-dimensional standard sample including a sample body having a semiconductor wafer shape, a plurality of pattern groups in the sample body, each of the plurality of pattern groups including a pattern layer including at least one metal pattern corresponding to a semiconductor structure, and an interlayer including an insulating material, and a combination pattern including the plurality of pattern groups, wherein the combination pattern is on a central portion of sample body and an edge portion of the sample body.

According to still another aspect of one or more embodiments, there is provided a three-dimensional standard sample including a plurality of pattern groups including at least one metal pattern among a first metal pattern corresponding to a line provided in a semiconductor structure or space provided in the semiconductor structure, a second metal pattern corresponding to a bump or a microbump provided in the semiconductor structure, a third metal pattern corresponding to a silicon through-electrode provided in the semiconductor structure, a fourth metal pattern corresponding to a redistribution line provided in the semiconductor structure, a fifth metal pattern corresponding to a bonding pad or a bonding interface provided in the semiconductor structure, and a sixth metal pattern of at least one of a cross shape, a pinwheel shape, and a polygonal donut shape corresponding to an offset of an X-ray or an angle change of the X-ray, and a sample body including the plurality of pattern groups respectively including a pattern layer including a metal pattern among the at least one metal pattern, and an interlayer of an insulating material, wherein a size of the metal pattern has a range of 0.1 μm to 4 μm, wherein a material of the metal pattern is at least one of copper (Cu), tungsten (W), molybdenum (Mo), gallium (Ga), aluminum (Al), and silicon (Si), and wherein a thickness of each of a pattern layer and an interlayer included in a metal pattern group among the plurality of pattern groups is different from a thickness of a pattern layer and an interlayer included in another metal pattern group among the plurality of pattern groups.

### BRIEF DESCRIPTION OF DRAWINGS

The above and other aspects, features, and advantages of embodiments will be more clearly understood from the following detailed description, taken in conjunction with the accompanying drawings, in which:

FIGS. 1A, 1B, 1C, and 1D are schematic diagrams of X-ray apparatuses in which a sample for evaluating an X-ray apparatus according to one or more embodiments;

FIGS. 2A, 2B, 2C, and 2D are images of application-specific integrated circuits (ASICs) measured by the X-ray apparatuses of one or more embodiments;

FIGS. 3A, 3B, 3C, and 3D are images of semiconductor through-silicon vias (TSVs) measured by the X-ray apparatuses of one or more embodiments;

FIG. 4 is a schematic perspective view of a sample for evaluating an X-ray apparatus having a pattern group formed by a first array according to one or more embodiments;

FIG. 5 is an enlarged view of a combination pattern of FIG. 4;

FIG. 6 is a schematic diagram schematically illustrating an example of the size of the combination pattern of FIG. 4;

FIG. 7A is a schematic diagram illustrating patterns forming a first pattern group of a sample for evaluating an X-ray apparatus according to one or more embodiments;

FIG. 7B is a schematic diagram illustrating patterns forming a second pattern group of a sample for evaluating an X-ray apparatus according to one or more embodiments;

FIG. 8 is a schematic diagram illustrating a line or space pattern among patterns of a sample for evaluating an X-ray apparatus in three dimensions according to one or more embodiments;

FIG. 9 is a schematic cross-sectional diagram taken along line B-B′ of FIG. 8;

FIG. 10 is a schematic diagram of a sample for evaluating an X-ray apparatus in which a combined pattern formed of a second array is formed of a different material according to one or more embodiments;

FIG. 11 is a schematic cross-sectional diagram illustrating a metal pattern of a first pattern group and a metal pattern of a second pattern group;

FIG. 12 is a schematic diagram illustrating an example of a process of calibrating a three-dimensional standard sample for evaluating an X-ray apparatus according to one or more embodiments; and

FIG. 13 is a schematic diagram illustrating an example of a mean time to failure (MTF) result of the apparatuses of FIGS. 1A to 1D having undergone the calibration process of FIG. 12.

### DETAILED DESCRIPTION

Hereinafter, example embodiments will be described with reference to the accompanying drawings.

Embodiments may be modified to have various other forms, and are provided to provide a more complete explanation to those skilled in the art. Accordingly, the shapes and sizes of elements in the drawings may be exaggerated for clear description, and elements indicated by the same symbol in the drawings refer to the same element.

In the present disclosure, the meaning of “connection” is a concept including not only “directly connected” but also “indirectly connected” through other configurations. Additionally, in some cases, it is a concept including all “electrically connected things.”

In the present disclosure, expressions such as “first,” “second” and the like are used to distinguish one component from another component and do not limit the order and/or importance of the components. In some cases, the first component may be named the second component, and similarly, the second component may be named the first component without departing from the scope of rights.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

The terminology used in the present disclosure is used to describe examples only and is not intended to limit the present inventive concept. At this time, singular expressions include plural expressions, unless the context clearly indicates otherwise.

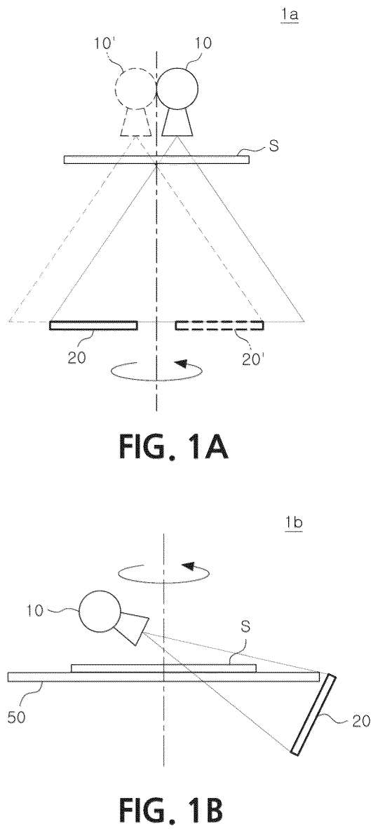

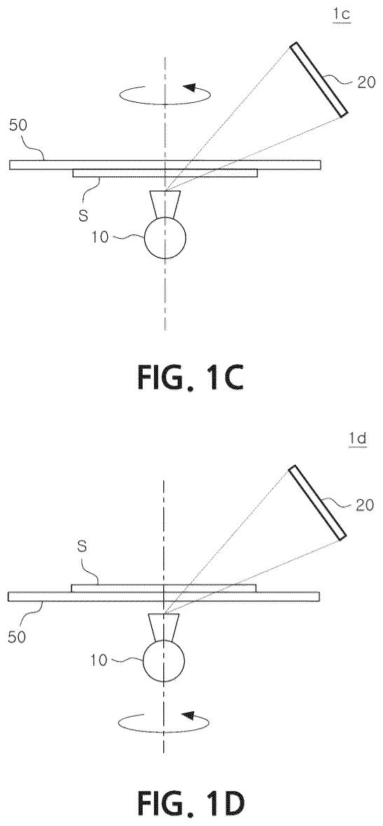

FIGS. 1A to 1D are schematic diagrams of X-ray apparatuses in which a sample S for evaluating an X-ray apparatus according to one or more embodiments is used.

When conducting an inline inspection of a semiconductor wafer, the semiconductor wafer may be moved to an X-ray apparatus chamber to perform an X-ray inspection of a semiconductor structure.

The X-ray apparatus installed in the X-ray apparatus chamber may have various configurations.

An X-ray apparatus for examining a sample S for an X-ray apparatus evaluation according to one or more embodiments includes an X-ray source 10 that generates X-rays so that X-rays are scattered, a stage 50 on which the sample S is seated, and a detector 20 that collects X-ray scattered light transmitted through the sample S to generate an actual image.

The X-ray apparatuses according to one or more embodiments may be configured in various manners as illustrated in FIGS. 1A to 1D, and may be distinguished according to, for example, the locations of the source 10 and the detector 20 and the rotating parts.

In an X-ray apparatus 1a of FIG. 1A, the source 10 is located at the upper portion and the detector 20 is located at the lower portion, with respect to the sample S. In addition, the source 10 and the detector 20 may rotate based on the central axis line.

In an X-ray apparatus 1b of FIG. 1B, the source 10 is located to be inclined above the sample S, with respect to the sample S, and the detector 20 is disposed to be inclined with respect to a surface of the stage 50, on a side opposite to the central axis line with respect to the source 10, and below the sample S to facilitate the reception of X-ray scattered light from the source 10 that is above the sample S.

In this case, the locations of the source 10 and the detector 20 are fixed, and the stage 50 supporting the sample S may rotate.

In the X-ray apparatus 1c of FIG. 1C, the source 10 is positioned corresponding to the lower portion of the central axis with respect to the sample S and coincides with the central axis, and the detector 20 is positioned at a position offset from the central axis line and inclined with respect to a surface of the stage 50 above the sample S.

In this case, the positions of the source 10 and the detector 20 are fixed, and the stage 50 supporting the sample S on the lower surface of the stage 50 may rotate.

In the X-ray apparatus 1d of FIG. 1D, the source 10 is positioned corresponding to the lower portion of the central axis with respect to the sample S and coincides with the central axis, and the detector 20 is positioned at a position offset from the central axis line and inclined with respect to a surface of the stage 50 above the sample S.

In this example, the positions of the source 10 and the detector 20 are fixed, and the stage 50 supporting the sample S on the upper surface of the stage 50 rotates.

The X-ray apparatuses 1a, 1b, 1c and 1d of the above-described embodiments are illustrative, and the locations of the source 10, the sample S, and the detector 20 may vary.

The X-ray apparatuses 1a, 1b, 1c and 1d of FIGS. 1A to 1D may measure not only semiconductor package products but also pre-process products (for example, BVNAD, W2W bonding, and the like) to form chips by engraving circuits on semiconductor wafers.

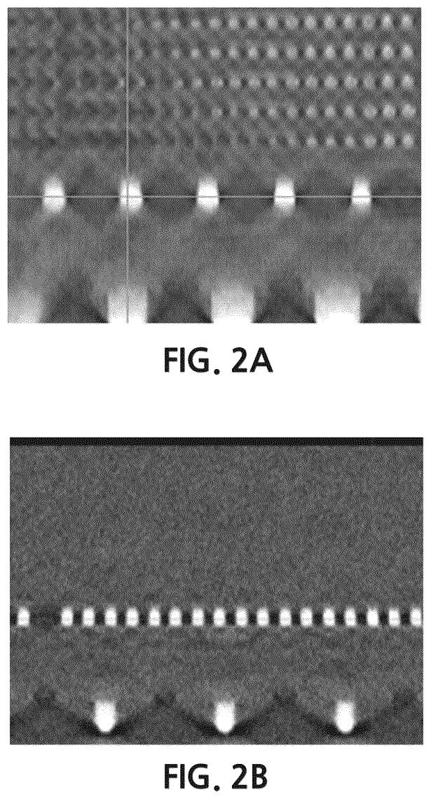

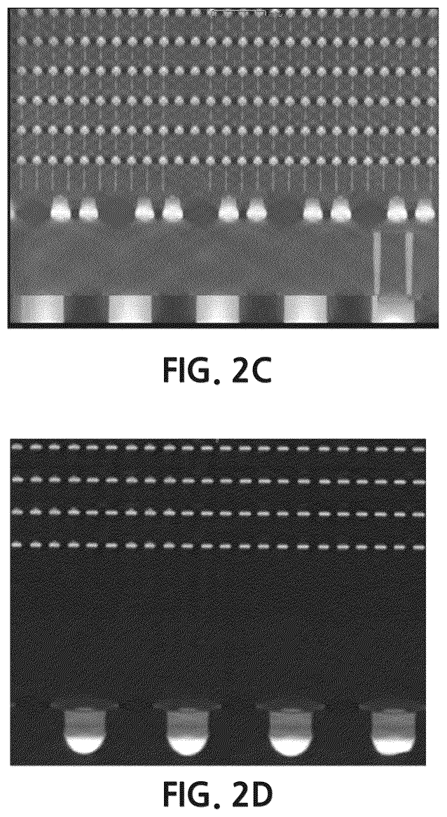

FIGS. 2A to 2D are images of application-specific integrated circuits (ASICs) measured by the X-ray apparatuses 1a, 1b, 1c and 1d of one or more embodiments.

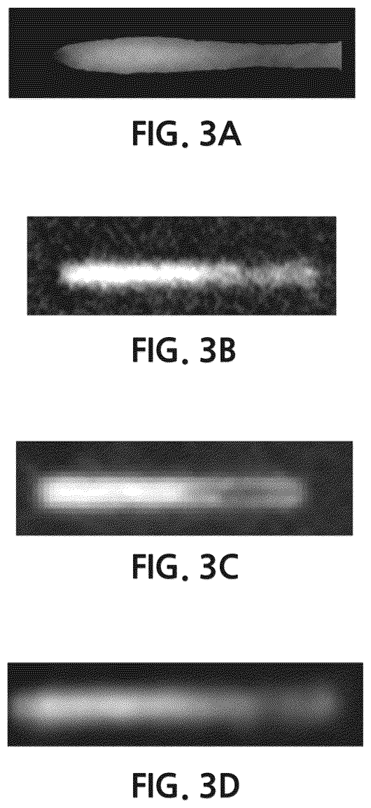

In addition, FIGS. 3A to 3D are images of semiconductor through-silicon vias (TSVs) measured by the X-ray apparatuses 1a, 1b, 1c and 1d of one or more embodiments.

The performance evaluation of X-ray apparatuses 1a, 1b, 1c and 1d may only be qualitatively determined by looking at the measured images of FIGS. 2A to 2D and FIGS. 3A to 3D to determine which apparatus has improved functions, but it may be difficult to quantitatively determine which equipment has improved functions based on the images alone.

Therefore, a three-dimensional standard sample may quantitatively analyze the performance of X-ray apparatuses 1a, 1b, 1c and 1d.

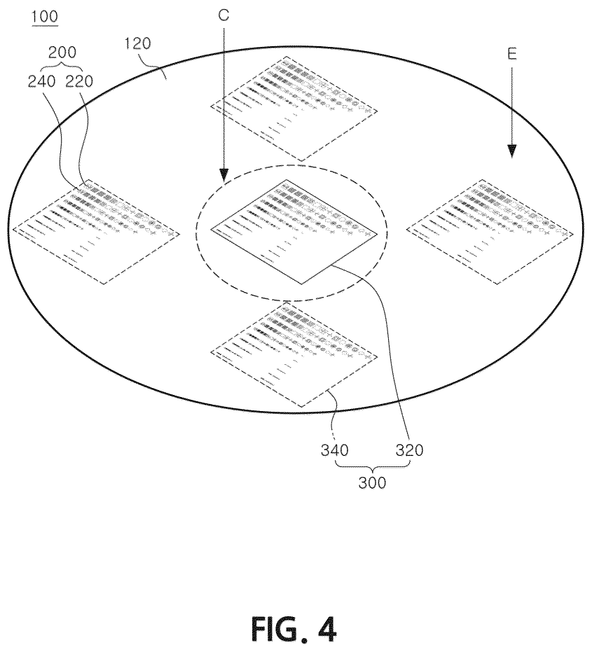

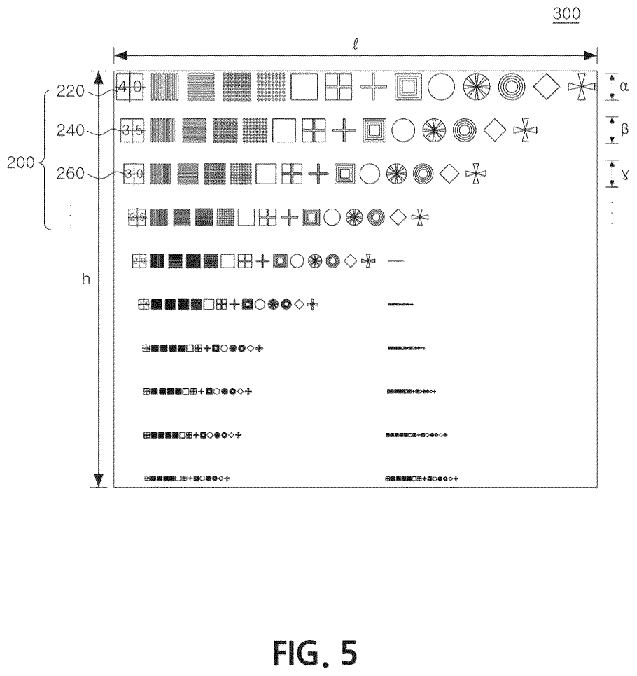

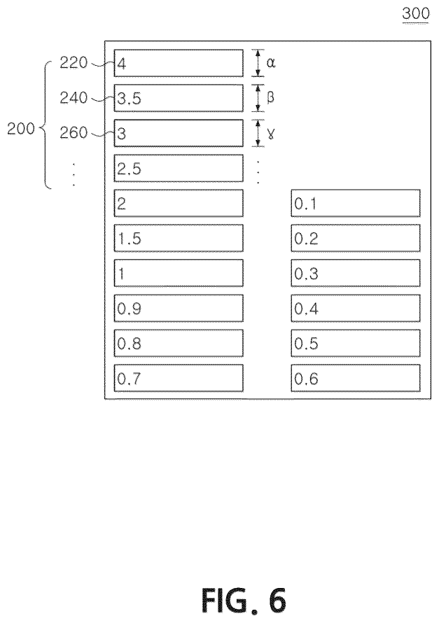

FIG. 4 is a schematic perspective view of a sample for evaluating an X-ray apparatus having a pattern group formed by a first array according to one or more embodiments, FIG. 5 is an enlarged view of a combination pattern of FIG. 4, and FIG. 6 is a schematic diagram schematically illustrating an example of the size of the combination pattern of FIG. 4.

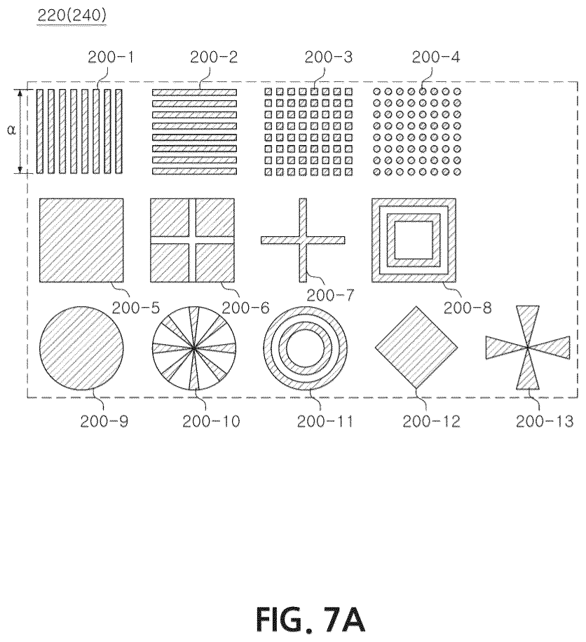

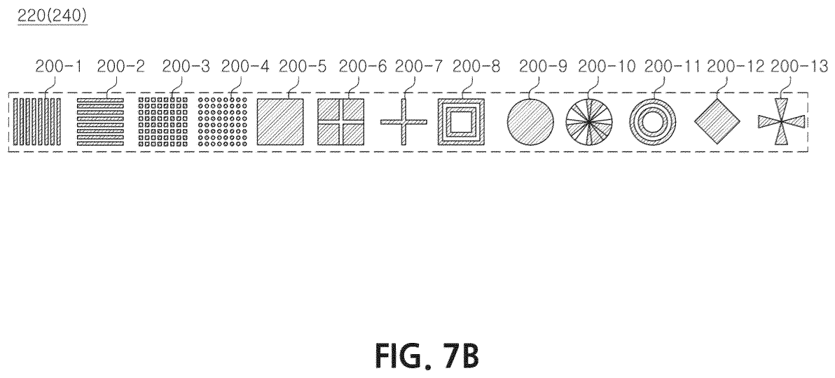

In addition, FIG. 7A is a schematic diagram illustrating patterns forming a first pattern group of a sample for evaluating an X-ray apparatus according to one or more embodiments, and FIG. 7B is a schematic diagram illustrating patterns forming a second pattern group of a sample for evaluating an X-ray apparatus according to one or more embodiments.

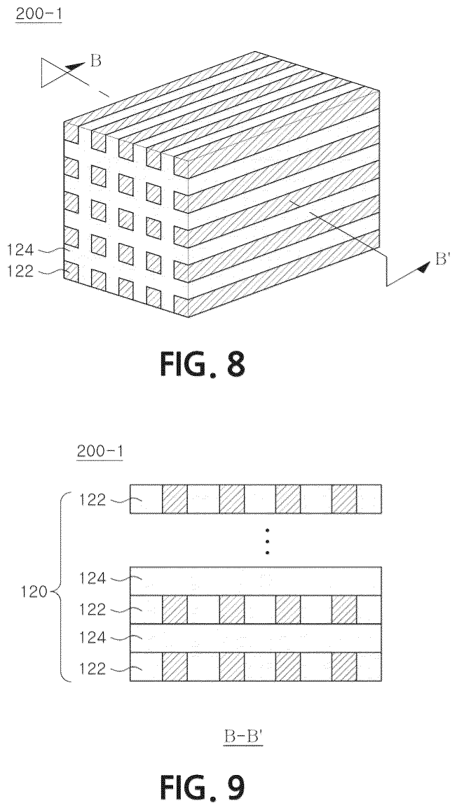

FIG. 8 is a schematic diagram illustrating a line or space pattern among patterns of a sample for evaluating an X-ray apparatus according to one or more embodiments in three dimensions. FIG. 9 is a schematic cross-sectional view taken along line B-B′ of FIG. 8.

Referring to FIGS. 4 to 9, a three-dimensional standard sample 100 for evaluating an X-ray apparatus includes a sample body 120, a metal pattern 200, and a combination pattern 300.

The sample body 120 is formed by stacking a pattern layer 122 having a metal pattern and an interlayer layer 124 of an insulating material in a plurality of layers (see FIG. 9). In addition, the sample body 120 may be manufactured as a three-dimensional standard sample 100 by a process of engraving a circuit on a semiconductor wafer using a semiconductor lamination method in the shape of a semiconductor wafer to form a chip.

The three-dimensional standard sample 100 of one or more embodiments is illustrated as a semiconductor wafer shape, but is not limited thereto, and as long as a circuit may be engraved using a semiconductor lamination method, there is no limitation on the shape.

A metal pattern 200 is disposed in the sample body 120. The metal pattern 200 in the sample body 120 may be at least one or more metal patterns 200-1, 200-2, 200-3, 200-4, . . . , 200-13, (see FIG. 7A and FIG. 7B).

The metal pattern 200 of the sample body 120 may also be configured in multiple configurations to correspond to various semiconductor structures. At least one or more metal patterns 200-1, 200-2, 200-3, 200-4, . . . , and 200-13 may be grouped and defined as a first pattern group 220, a second pattern group 240, and the like, respectively.

The number of pattern groups 220 and 240 may also be arbitrarily determined, and the metal patterns 200 may be grouped by changing the size or material to form pattern groups 220 and 240.

The pattern groups 220 and 240 of FIGS. 7A and 7B are composed of 13 metal patterns 200-1, 200-2, 200-3, 200-4, . . . , and 200-13 as one pattern group 220, 240, but may optionally include at least one or more metal patterns.

The combination pattern 300 may include a plurality of pattern groups 220 and 240 grouped together. In this example, the number of pattern groups 220 and 240 forming the combination pattern 300 is not particularly limited.

The size and number of the combination patterns 300 are determined in consideration of the size of the semiconductor wafer. For example, a size of the semiconductor wafer may be 300 mm (12 inches), but embodiments are not limited thereto.

The sample body 120 may have a size such as a diameter of 300 mm, and when the sample body 120 is viewed from a plan view, the horizontal length (l) and vertical length (h) of the combination pattern 300 in the example embodiment of FIG. 5 may be 1 mm×1 mm.

Since the average field of view of the X-ray apparatus in the high-resolution mode is 1 mm×1 mm, the combination pattern 300 may need to be adjusted to a size smaller than the 1 mm×1 mm in consideration thereof.

When the sample body 120 is viewed from a plan view, a central portion C of the sample body 120 may be a range of about 20 to 30% (a diameter of 60 to 90 mm) from a center of the sample body 120, and an edge portion E of the sample body 120 may be a portion surrounding and adjacent to the central portion C excluding the central portion C. For example, the central portion C may have a circular shape and the edge portion E may have a ring shape.

The plurality of combination patterns 300 include combination patterns 320 located at the central portion C and combination patterns 340 located at the edge portion E, and may be arranged in various manners.

In a first array of the combination patterns 300 of FIG. 4, one combination pattern 320 located at the central portion C and four combination patterns 340 located at the edge portion E are arranged, but embodiments are not limited thereto.

The metal pattern 200 may have various patterns based on a semiconductor structure.

As illustrated in FIGS. 7A and 7B, the metal pattern 200 may include patterns 200-1 and 200-2 corresponding to a line or space appearing in the semiconductor structure.

In addition, the metal pattern 200 may include patterns 200-3 and 200-4 corresponding to a bump or microbump provided in the semiconductor structure, and patterns 200-5 and 200-6 corresponding to a through-silicon via (TSV) provided in the semiconductor structure.

In addition, the metal pattern 200 may include patterns 200-7 and 200-8 corresponding to a redistribution line provided in the semiconductor structure, and the metal pattern 200 may include patterns 200-9 and 200-12 corresponding to a bonding pad or bonding interface provided in the semiconductor structure.

Additionally, the metal pattern 200 may include at least one or more patterns 200-10, 200-11 and 200-13 among a cross shape, a pinwheel shape, and a polygonal donut shape corresponding to the offset and angle change of the X-ray.

In the metal pattern 200 described above, a metal pattern, corresponding to a line or space provided in a semiconductor structure may be defined as a first metal pattern 200-1, 200-2, a metal pattern, corresponding to a bump or microbump provided in a semiconductor structure may be defined as a second metal pattern 200-3, 200-4, a metal pattern, corresponding to a silicon through-electrode provided in a semiconductor structure may be defined as a third metal pattern 200-5, 200-6, a metal pattern, corresponding to a redistribution line provided in a semiconductor structure may be defined as a fourth metal pattern 200-7, 200-8, a metal pattern, corresponding to a bonding pad or bonding interface provided in a semiconductor structure may be defined as a fifth metal pattern 200-9, 200-12, and at least one metal pattern among a cross shape, a pinwheel shape, and a polygonal donut shape corresponding to an offset or angle change of an X-ray may be defined as a sixth metal pattern 200-10, 200-11, 200-13.

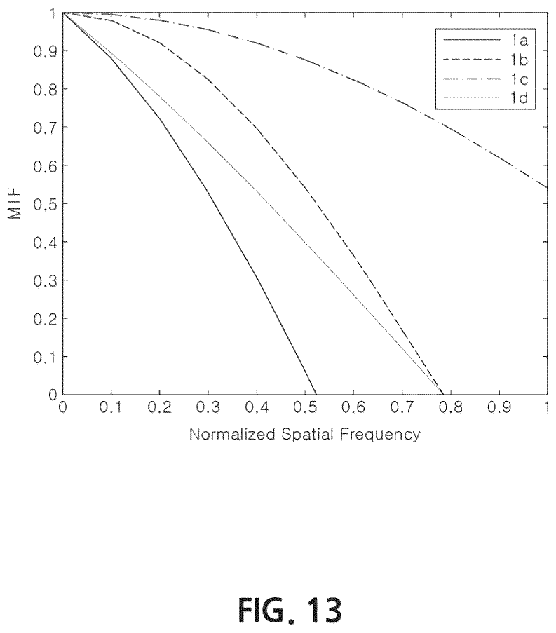

In FIGS. 7A and 7B, 13 metal patterns are illustrated, including the first metal pattern 200-1, 200-2, the second metal pattern 200-3, 200-4, the third metal pattern 200-5, 200-6, the fourth metal pattern 200-7, 200-8, the fifth metal pattern 200-9, 200-12, and the sixth metal pattern 200-10, 200-11, 200-13, but a number or a shape of the pattern may be selected to group the patterns into the first pattern group 220 or the second pattern group 240.

To digitize many images with a single three-dimensional standard sample 100, various patterns are provided, and different materials may also be selected for each metal pattern 200, as pattern groups 220 and 240.

The size of the metal pattern 200 and the size of the pattern groups 220 and 240 may be selected differently as illustrated in FIG. 5, but may have a range of 0.1 μm to 4 μm.

Considering the average field of view in the high-resolution mode of the X-ray apparatus, the combined pattern 300 has a range of 1 mm×1 mm, and thus, should be selected from an appropriate size such as the first pattern group 220, the second pattern group 240, the third pattern group 260, and the like.

As illustrated in FIG. 5 and FIGS. 6, 16 pattern groups 220 may be provided. In this example, the size of the metal pattern 200 may be selected in various manners, and since the theoretical limit of the resolution of the X-ray apparatus is 0.1 μm, a minimum size of the pattern groups 220, 240, 260 . . . is selected as 0.1 μm. The sizes (α, β, γ. . . ) of the pattern groups 220, 240, 260 . . . may be 0.1 μm, 0.2 μm, 0.3 μm, 0.4 μm, 0.5 μm, 0.6 μm, 0.7 μm, 0.8 μm, 0.9 μm, 1.0 μm, 1.5 μm, 2.0 μm, 2.5 μm, 3.0 μm, 3.5 μm, or 4.0 μm to correspond to various semiconductor structures as the pattern size gradually increases.

As the average field of view in the high-resolution mode of the X-ray apparatus has a limit of 1 mm×1 mm, a size of the pattern groups 220, 240, 260 . . . should be equal to or less than 4.0 μm.

A selected material of the metal pattern 200 may be at least one of copper (Cu), tungsten (W), molybdenum (Mo), gallium (Ga), aluminum (Al), and silicon (Si).

The material of the metal pattern 200 may be selected differently for each metal pattern or each pattern group.

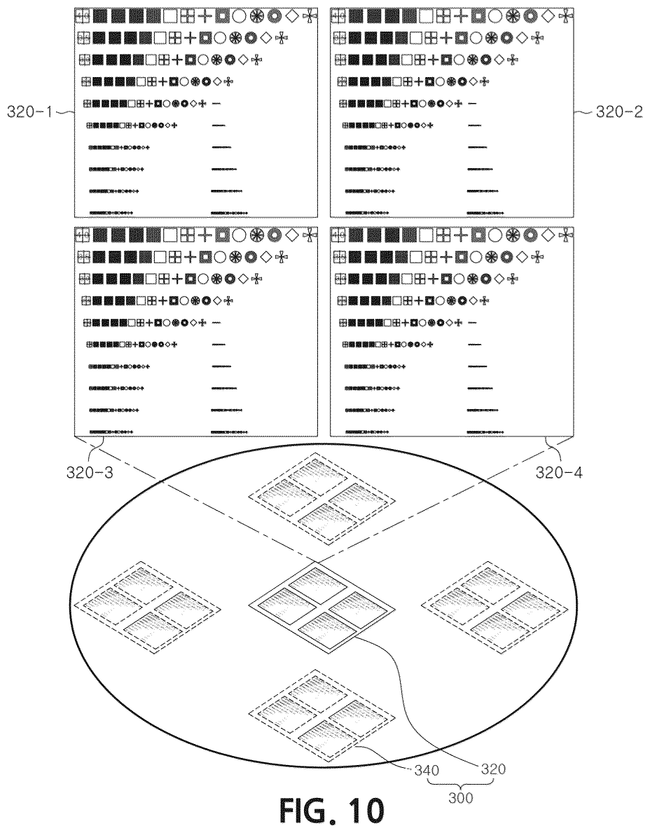

FIG. 10 is a schematic diagram of a sample for evaluating an X-ray apparatus, in which a combination pattern formed of a second array is formed of a different material according to one or more embodiments.

In the example embodiment of FIG. 10, four combination patterns 320-1, 320-2, 320-3 and 320-4 may be included within one combination pattern 320, 340.

The respective metal patterns of the four combination patterns 320-1, 320-2, 320-3, and 320-4 may be formed of different materials. For example, the metal pattern of the first combination pattern 320-1 may be Cu, the metal pattern of the second combination pattern 320-2 may be W, the metal pattern of the third combination pattern 320-3 may be Mo, and the metal pattern of the fourth combination pattern 320-4 may be Al.

A material of the metal pattern forming respective combination patterns 320-1, 320-2, 320-3 and 320-4 may be at least one selected from Cu, W, Mo, Ga, Al, and Si.

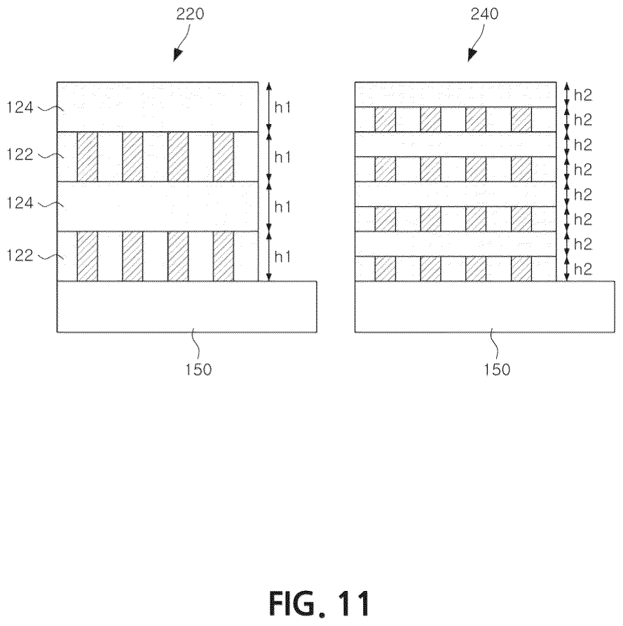

FIG. 11 provides schematic cross-sectional views of the metal pattern of the first pattern group 220 and the metal pattern of the second pattern group 240.

Referring to FIG. 11, an interlayer layer 124 and a pattern layer 122a provided the metal pattern are repeatedly laminated on a silicon substrate 150.

In the three-dimensional standard sample 100 of one or more embodiments, a thickness h1 of each of the pattern layer 122 and the interlayer layer 124 of the first pattern group 220 is formed different from a thickness h2 of each of the pattern layer 122 and the interlayer layer 124 of the second pattern group 240.

According to one or more embodiments, a thickness of a metal pattern forming a different pattern group may be different to respond to more diverse semiconductor structures and enable X-ray apparatus evaluation to be performed.

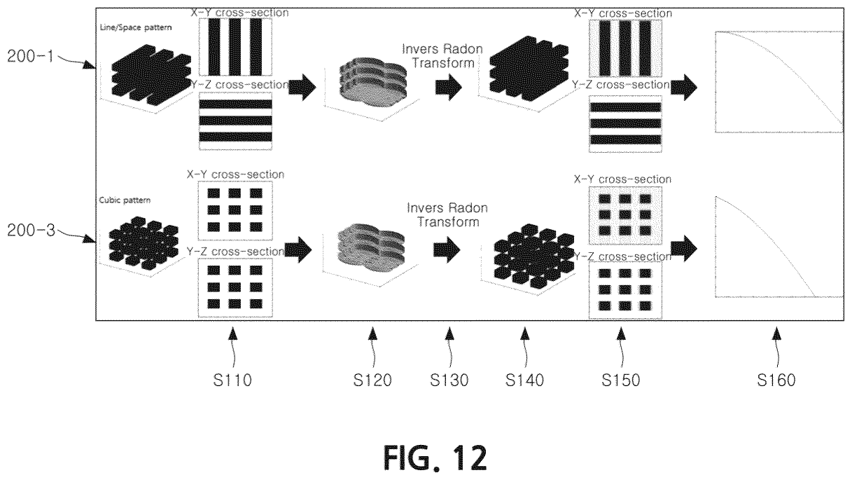

FIG. 12 is a schematic diagram illustrating an example of a process for calibrating a three-dimensional standard sample 100 for evaluating an X-ray apparatus according to one or more embodiments, and FIG. 13 is a schematic diagram illustrating an example of MTF results by the apparatuses of FIG. 1A to FIG. 1D on the three-dimensional standard sample of this embodiment photographed with the apparatuses of FIG. 1A to FIG. 1D and subjected to the calibration process of FIG. 12.

Referring to FIG. 12, a three-dimensional MTF may be obtained by simulation using the three-dimensional standard sample 100 for evaluating an X-ray apparatus according to one or more embodiments.

For example, a process of obtaining a three-dimensional MTF using a line/space first metal pattern 200-1 and a cubic pattern second metal pattern 200-3 of a three-dimensional standard sample 100 is described.

The size and the like of the spatial interval of the sample are measured to calibrate the intervals in the X-Y cross-section and the Y-Z cross-section (S110), respectively. Next, a Radon transform is performed to obtain a sinogram (S120).

The image of the sinogram is subjected to an inverse radon transform (S130), thereby obtaining a restored image with a shape similar to the result of the shape subjected to the sample measurement calibration (S140).

The image of the inverse Radon transform restoration result is calibrated in the X-Y and Y-Z cross sections (S150), and the MTF value is interpreted according to the X-Y and Y-Z cross sections by comparing the same with the result at the time of sample measurement.

MTF refers to the ability of the original mask image to be transferred to the wafer in lithography.

Numerically, an MTF may be expressed as MTF=(Imax−Imin)/(Imax+Imin).

Transferring the wafer of semiconductor formation as is necessary, but as X-rays have loss due to diffraction, it may be difficult to transfer the wafer shape as is, and intensity loss due may occur.

In FIG. 13, the MTF value being 1 quantitatively may be the most ideal value for transferring the semiconductor structure as is. Normalized spatial frequency refers to an interval between metal patterns. For example, since the MTF value of the 1c X-ray apparatus is the greatest at a spatial frequency of 0.3, quantitatively the 1c X-ray apparatus may have the most accurate performance.

As set forth above, according to a three-dimensional standard sample for evaluating an X-ray apparatus according to one or more embodiments, performance of an X-ray apparatus may be evaluated with various semiconductor structure patterns including a three-dimensional performance evaluation in a depth direction as a single three-dimensional standard sample.

In addition, according to a three-dimensional standard sample for evaluating an X-ray apparatus according to one or more embodiments, quantitative evaluation of an X-ray apparatus may be performed, and thus, a more reliable apparatuses may be selected.

While embodiments have been illustrated and described above, it will be apparent to those skilled in the art that modifications and variations could be made without departing from the scope of the present inventive concept as defined by the appended claims and their equivalents.

What is claimed is:

1. A three-dimensional standard sample comprising:
a sample body;
a first pattern group and a second pattern group in the sample body, each of the first pattern group and the second pattern group comprising:
a pattern layer that comprises a metal pattern; and
an interlayer layer that comprises an insulating material; and
a plurality of combination patterns respectively comprising the first pattern group and the second pattern group,
wherein at least one of the plurality of combination patterns is in a central portion of the sample body and an edge portion of the sample body.

2. The three-dimensional standard sample of claim 1, wherein the sample body has a semiconductor wafer shape.

3. The three-dimensional standard sample of claim 1, wherein the metal pattern corresponds to a line provided in a semiconductor structure or a space provided in the semiconductor structure.

4. The three-dimensional standard sample of claim 1, wherein the metal pattern corresponds to a bump provided in a semiconductor structure or a microbump provided in the semiconductor structure.

5. The three-dimensional standard sample of claim 1, wherein the metal pattern corresponds to a silicon through-electrode provided in a semiconductor structure.

6. The three-dimensional standard sample of claim 1, wherein the metal pattern corresponds to a redistribution line provided in a semiconductor structure.

7. The three-dimensional standard sample of claim 1, wherein the metal pattern corresponds to a bonding pad provided in a semiconductor structure or a bonding interface provided in the semiconductor structure.

8. The three-dimensional standard sample of claim 1, wherein the metal pattern comprises at least one of a cross shape, a pinwheel shape, and a polygonal donut shape corresponding to an offset of an X-ray and an angle change of the X-ray.

9. The three-dimensional standard sample of claim 1, wherein at least one of the first pattern group and the second pattern group comprises at least two of:
a first metal pattern corresponding to a line provided in a semiconductor structure or a space provided in the semiconductor structure,
a second metal pattern corresponding to a bump provided in the semiconductor structure or a microbump provided in the semiconductor structure,
a third metal pattern corresponding to a silicon through-electrode provided in the semiconductor structure,
a fourth metal pattern corresponding to a redistribution line provided in the semiconductor structure,
a fifth metal pattern corresponding to a bonding pad provided in the semiconductor structure or a bonding interface provided in the semiconductor structure, and
a sixth metal pattern corresponding to at least one of a cross shape, a pinwheel shape, and a polygonal donut shape corresponding to an offset of an X-ray and an angle change of the X-ray.

10. The three-dimensional standard sample of claim 1, wherein at least one of the first pattern group and the second pattern group comprises a plurality of metal patterns having a strip shape in a row or a plurality of metal patterns having a rectangular shape in a plurality of rows.

11. The three-dimensional standard sample of claim 10, wherein at least one of a size and a material a metal pattern included in the first pattern group and at least one of a size and a material of a metal pattern included in the second pattern group are different from each other.

12. The three-dimensional standard sample of claim 1, wherein a size of the metal pattern is in a range of 0.1 μm to 4 μm.

13. The three-dimensional standard sample of claim 1, wherein a material of the metal pattern is at least one of copper (Cu), tungsten (W), molybdenum (Mo), gallium (Ga), aluminum (Al), and silicon (Si).

14. The three-dimensional standard sample of claim 1, wherein each of the plurality of combination patterns comprises four pattern groups, and
wherein at least one of the plurality of combination patterns included in the central portion and the plurality of combination patterns included in the edge portion has a 2×2 arrangement.

15. The three-dimensional standard sample of claim 1, wherein a thickness of a pattern layer and a thickness of an interlayer included in the first pattern group is different from a thickness of a pattern layer and a thickness of an interlayer included in the second pattern group.

16. A three-dimensional standard sample comprising:
a sample body having a semiconductor wafer shape;
a plurality of pattern groups in the sample body, each of the plurality of pattern groups comprising:
a pattern layer comprising at least one metal pattern corresponding to a semiconductor structure; and
an interlayer comprising an insulating material; and
a combination pattern comprising the plurality of pattern groups,
wherein the combination pattern is on a central portion of sample body and an edge portion of the sample body.

17. The three-dimensional standard sample of claim 16, wherein the at least one metal pattern comprises at least one of:
a first metal pattern corresponding to a line provided in the semiconductor structure or space provided in the semiconductor structure,
a second metal pattern corresponding to a bump provided in the semiconductor structure or a microbump provided in the semiconductor structure,
a third metal pattern corresponding to a silicon through-electrode provided in the semiconductor structure,
a fourth metal pattern corresponding to a redistribution line provided in the semiconductor structure,
a fifth metal pattern corresponding to a bonding pad provided in the semiconductor structure or a bonding interface provided in the semiconductor structure, and
a sixth metal pattern having at least one of a cross shape, a pinwheel shape, and a polygonal donut shape corresponding to an offset or an angle change of an X-ray, and
wherein the plurality of pattern groups comprise at least two metal patterns.

18. The three-dimensional standard sample of claim 16, wherein a size of the metal pattern is in a range of 0.1 μm to 4 μm, and
wherein a material of the metal pattern is at least one of copper (Cu), tungsten (W), molybdenum (Mo), gallium (Ga), aluminum (Al), and silicon (Si).

19. The three-dimensional standard sample of claim 16, wherein a thickness of each of a pattern layer and an interlayer of at least one metal pattern included in a pattern group among the plurality of pattern groups is different from a thickness between a pattern layer and an interlayer of another metal pattern included in the pattern group.

20. A three-dimensional standard sample comprising:
a plurality of pattern groups comprising at least one metal pattern among a first metal pattern corresponding to a line provided in a semiconductor structure or space provided in the semiconductor structure, a second metal pattern corresponding to a bump or a microbump provided in the semiconductor structure, a third metal pattern corresponding to a silicon through-electrode provided in the semiconductor structure, a fourth metal pattern corresponding to a redistribution line provided in the semiconductor structure, a fifth metal pattern corresponding to a bonding pad or a bonding interface provided in the semiconductor structure, and a sixth metal pattern of at least one of a cross shape, a pinwheel shape, and a polygonal donut shape corresponding to an offset of an X-ray or an angle change of the X-ray; and
a sample body comprising the plurality of pattern groups respectively comprising a pattern layer comprising a metal pattern among the at least one metal pattern, and an interlayer of an insulating material,
wherein a size of the metal pattern has a range of 0.1 μm to 4 μm,
wherein a material of the metal pattern is at least one of copper (Cu), tungsten (W), molybdenum (Mo), gallium (Ga), aluminum (Al), and silicon (Si), and
wherein a thickness of each of a pattern layer and an interlayer included in a metal pattern group among the plurality of pattern groups is different from a thickness of a pattern layer and an interlayer included in another metal pattern group among the plurality of pattern groups.
